(19) United States
(12) Patent Application Publication
(10) Pub. No.: US 2025/0325118 A1
(43) Pub. Date: Oct. 23, 2025

(54) PLAYPEN CONNECTING PIECE

(71) Applicant: Anhui Hope Child Product Co., Ltd., Hefei (CN)

(72) Inventors: Bobo Gu, Hefei (CN); Zhihao Dong, Hefei (CN)

(21) Appl. No.: 19/011,477

(22) Filed: Jan. 6, 2025

(30) Foreign Application Priority Data
Apr. 19, 2024 (CN) 202410473241.1

(51) Int. Cl. A47D 13/06

(52) U.S. Cl. CPC A47D 13/061

(57) ABSTRACT

The present disclosure relates to the technical field of children's playpens, and in particular to a playpen connecting piece. An upper corner joint and a lower corner joint are included, with the upper corner joint and the lower corner joint rotatably connected to adjacent playpen components respectively. In the present disclosure, a plurality of sets of locking structures are utilized in conjunction with an angle adjustment structure; and an angle between fences, after being adjusted, is fixed with the locking structures, ensuring that the angle between the fences remains unchanged even when subjected to external forces. The structure is easy for operation.

### CROSS-REFERENCE TO RELATED APPLICATION

This application claims priority of Chinese Patent Application No. 202410473241.1, filed on Apr. 19, 2024, the entire contents of which are incorporated herein by reference.

### TECHNICAL FIELD

The present disclosure relates to the technical field of children's playpens, and in particular to a playpen connecting piece.

### BACKGROUND

Children's playpens, also known as children's game fences, guardrails for kids, and safety fences, are predominantly in a structure formed by plastic and wooden materials on the market, mainly serving for freeing mother's hands while providing a safe and comfortable environment for babies aged 6 months to 3 years.

In prior art, some connecting pieces for the playpens are connected in a snap-fit manner, while others are connected in a movable manner, leading to difficulties in adjusting the angles between adjacent fences. Additionally, when locked, the angles between the fences may continue to change under external forces.

### SUMMARY

An objective of the present disclosure is to provide a playpen connecting piece, to overcome the shortcoming that angles cannot be easily adjusted in the prior art.

To realize the above objective, the present disclosure employs the following technical solutions.

A playpen connecting piece is designed, including an upper corner joint and a lower corner joint, with the upper corner joint and the lower corner joint rotatably connected to adjacent playpen components respectively.

An insertion slot is disposed at an upper part of the upper corner joint, and an unlocking button is inserted into the insertion slot; a locking piece is sleeved between inner sides of the upper corner joint and the lower corner joint; a reset spring is sleeved on a lower end of an outer side of the locking piece; an angle adjustment structure is arranged between a top of the locking piece and the unlocking button; and the angle adjustment structure serves for adjusting an angle between the upper corner joint and the lower corner joint.

A first locking structure is arranged between an upper part of the locking piece and the upper corner joint, and a second locking structure is arranged between a lower part of the locking piece and the lower corner joint.

Preferably, the angle adjustment structure includes a partition plate, an insertion plate, a through hole, a tooth groove, and a shallow tooth groove; the partition plate is mounted on an inner side of the insertion slot; the through hole is disposed on the partition plate; the tooth groove is disposed at a bottom of the insertion plate; the insertion plate passes through the through hole and extends below the partition plate; and the tooth groove and the shallow tooth groove cooperate with each other.

Preferably, the first locking structure includes a deep tooth groove and locking teeth; the locking teeth are arranged in a circular array on the inner side of the upper corner joint; the deep tooth groove is mounted at an upper end of an outer side of the locking piece; and the deep tooth groove and the locking teeth cooperate with each other.

Preferably, when the locking piece descends, the deep tooth groove disengages from the locking teeth.

Preferably, the second locking structure includes an outer tooth ring and an inner tooth ring; the inner tooth ring is arranged inside the lower corner joint, and the outer tooth ring is mounted at a lower part of the outer side of the locking piece; and when the upper corner joint and the lower corner joint are locked, the outer tooth ring is clamped on an inner side of the inner tooth ring, and the inner tooth ring cooperates with the outer tooth ring.

Preferably, when the upper corner joint and the lower corner joint are in an unlocked state, the outer tooth ring descends until the outer tooth ring disengages from the inner tooth ring.

Preferably, through-type positioning holes are uniformly disposed on the partition plate, positioning blocks are mounted at a lower end of the unlocking button, and the positioning blocks are inserted into the positioning holes at different positions.

Preferably, the unlocking button is circular and a size thereof matches that of the insertion slot.

Preferably, a base is clamped at a bottom of the lower corner joint.

Preferably, a through-type first communicating hole is disposed at the top of the locking piece, a through-type second communicating hole is disposed in a middle portion of the base, and the first communicating hole passes through the locking piece to be intercommunicated with the second communicating hole.

The playpen connecting piece proposed in the present disclosure has the following beneficial effects. A plurality of sets of locking structures are utilized in conjunction with an angle adjustment structure; and an angle between fences, after being adjusted, is fixed with the locking structures, ensuring that the angle between the fences remains unchanged even when subjected to external forces. The structure is easy for operation.

### BRIEF DESCRIPTION OF THE DRAWINGS

FIG. 1 is a schematic structural diagram of a playpen connecting piece according to the present disclosure.

FIG. 2 is a structural section view of the playpen connecting piece according to the present disclosure.

FIG. 3 is a schematic diagram of an external structure of the playpen connecting piece according to the present disclosure.

Reference numerals and denotations thereof: 1—upper corner joint, 2—unlocking button, 3—positioning block, 4—insertion plate, 5—tooth groove, 6—insertion slot, 7—playpen component, 8—lower corner joint, 9—inner tooth ring, 10—reset spring, 11—shallow tooth groove, 12—deep tooth groove, 13—outer tooth ring, 14—base, 15—positioning hole, 16—through hole, 17—locking piece, 18—partition plate, 19—locking tooth, 20—first communicating hole, and 21—second communicating hole.

### DETAILED DESCRIPTION

The technical solutions of the examples in the present disclosure will be described clearly and completely with reference to the accompanying drawings of the examples in the present disclosure below. Obviously, the examples described are only some, rather than all examples of the present disclosure.

### Example 1

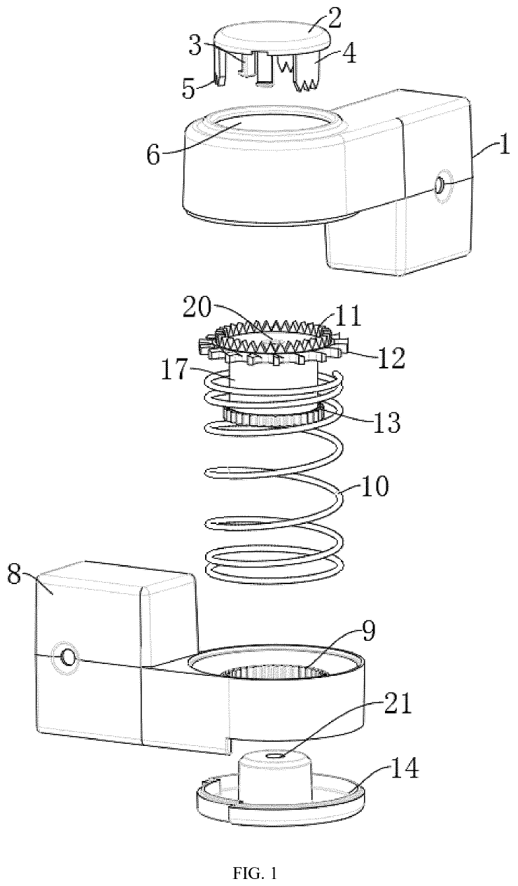

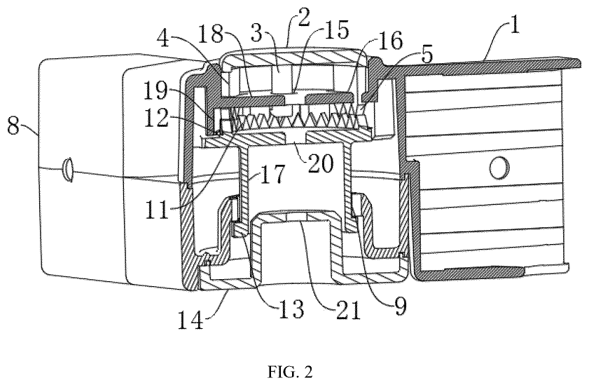

Referring to FIGS. 1-2, a playpen connecting piece includes an upper corner joint 1 and a lower corner joint 8, with the upper corner joint 1 and the lower corner joint 8 rotatably connected to adjacent playpen components 7 respectively.

An insertion slot 6 is disposed at an upper part of the upper corner joint 1, and an unlocking button 2 is inserted into the insertion slot 6. A locking piece 17 is sleeved between inner sides of the upper corner joint 1 and the lower corner joint 8. A reset spring 10 is sleeved on a lower end of an outer side of the locking piece 17. An angle adjustment structure is arranged between a top of the locking piece 17 and the unlocking button 2. The angle adjustment structure serves for adjusting an angle between the upper corner joint 1 and the lower corner joint 8.

A first locking structure is arranged between an upper part of the locking piece 17 and the upper corner joint 1, and a second locking structure is arranged between a lower part of the locking piece 17 and the lower corner joint 8.

The angle adjustment structure includes a partition plate 18, an insertion plate 4, a through hole 16, a tooth groove 5, and a shallow tooth groove 11. The partition plate 18 is mounted on an inner side of the insertion slot 6. The through hole 16 is disposed on the partition plate 18. The tooth groove 5 is disposed at a bottom of the insertion plate 4. The insertion plate 4 passes through the through hole 16 and extends below the partition plate 18. The tooth groove 5 and the shallow tooth groove 11 cooperate with each other.

The first locking structure includes a deep tooth groove 12 and locking teeth 19. The locking teeth 19 are arranged in a circular array on the inner side of the upper corner joint 1. The deep tooth groove 12 is mounted at an upper end of an outer side of the locking piece 17. The deep tooth groove 12 and the locking teeth 19 cooperate with each other. When the locking piece 17 descends, the deep tooth groove 12 disengages from the locking teeth 19.

The second locking structure includes an outer tooth ring 13 and an inner tooth ring 9. The inner tooth ring 9 is arranged inside the lower corner joint 8, and the outer tooth ring 13 is mounted at a lower part of the outer side of the locking piece 17. When the upper corner joint 1 and the lower corner joint 8 are locked, the outer tooth ring 13 is clamped on an inner side of the inner tooth ring 9, and the inner tooth ring 9 cooperates with the outer tooth ring 13.

When the upper corner joint 1 and the lower corner joint 8 are in an unlocked state, the outer tooth ring 13 descends until the outer tooth ring 13 disengages from the inner tooth ring 9.

Through-type positioning holes 15 are uniformly disposed on the partition plate 18, positioning blocks 3 are mounted at a lower end of the unlocking button 2, and the positioning blocks 3 are inserted into the positioning holes 15 at different positions. The unlocking button 2 is circular and a size thereof matches that of the insertion slot 6.

The upper corner joint 1 and the lower corner joint 8 are rotatably arranged between two adjacent fence components 7 through the locking piece 17. The unlocking button 2 is inserted into the inner side of the insertion slot 6, and the positioning blocks 3 at the bottom of the unlocking button 2 cooperate with the positioning holes 15 on the partition plate 18, allowing the unlocking button 2 to be quickly inserted into the inner side of the insertion slot 6.

When an angle between the fence components 7 requires to be adjusted, as the tooth groove 5 at the bottom of the insertion plate 4 fits into the shallow tooth groove 11 on the upper part of the locking piece 17, as shown in FIG. 2, during pressing the unlocking button 2 downwards, the tooth groove 5 slowly enters the shallow tooth groove 11. During entering, the tooth groove 5 not only drives the shallow tooth groove 11 to rotate by a certain angle, but also exerts a vertical force that drives the shallow tooth groove 11 and the locking piece 17 to move downwards together. At this point, the reset spring 10 arranged on the outer side of the locking piece 17 and positioned between the upper corner joint 1 and the lower corner joint 8, is compressed and gains tension. During the downward movement of the locking piece 17, the deep tooth groove 12 disengages from the locking teeth 19, transitioning from an engaged state to a disengaged state. As the locking piece 17 moves downwards, the outer tooth ring 13 on the locking piece 17 disengages from the inner tooth ring 9 on the lower corner joint 8, causing the locking piece 17 to lose its restraint on the upper corner joint 1 and the lower corner joint 8. At this point, the fence component 7 can be adjusted.

Teeth outside the locking teeth 19 are not inserted into grooves at the edge of the deep tooth groove 12, but rather the teeth of the locking teeth 19 and teeth of the deep tooth groove 12 abut against each other. Similarly, the inner tooth ring 9 and the outer tooth ring 13 below do the same. The fence component 7 will not be locked even if the external force is removed at this time. When the unlocking button 2 is pressed again, the tooth groove 5 drives the shallow tooth groove 11 to rotate a certain distance. At this point, the teeth outside the locking teeth 19 align with the grooves at the edge of the deep tooth groove 12, and the inner tooth ring 9 and the outer tooth ring 13 below do the same. At this point, after removing the external force from the unlocking button 2, the deep tooth groove 12 can be effectively pushed into the locking teeth 19 under the tension of the reset spring 10, and the inner tooth ring 9 and the outer tooth ring 13 can engage with each other.

### Example 2

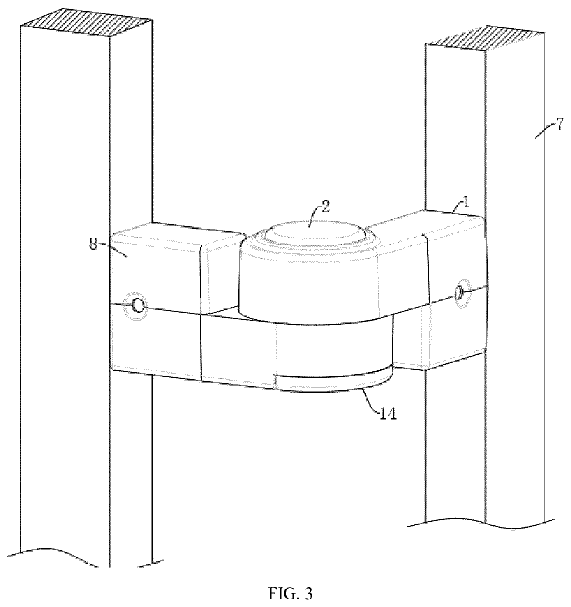

Referring to FIGS. 1-3, the difference between this example and Example 1 is that: a base 14 is clamped at a bottom of the lower corner joint 8, a through-type first communicating hole 20 is disposed at a top of the locking piece 17, a through-type second communicating hole 21 is disposed in a middle portion of the base 14, and the first communicating hole 20 passes through the locking piece 17 to be intercommunicated with the second communicating hole 21.

After the unlocking button 2 is mounted inside the insertion slot 6, to prevent the negative pressure generated inside the structure, the base 14 is designed as a hollow structure with a convex middle part. Additionally, the interior of the locking piece 17 is hollow, with an open lower end. The first communicating hole 20 and the second communicating hole 21 are disposed on the locking piece 17 and the base 14, respectively, to facilitate air convection, preventing the unlocking button 2, when requires to be pulled out, from becoming stuck due to negative pressure.

An operation principle of the device is as follows.

The upper corner joint 1 and the lower corner joint 8 are rotatably arranged between two adjacent fence components 7 through the locking piece 17. The unlocking button 2 is inserted into the inner side of the insertion slot 6, and the positioning blocks 3 at the bottom of the unlocking button 2 cooperate with the positioning holes 15 on the partition plate 18, allowing the unlocking button 2 to be quickly inserted into the inner side of the insertion slot 6.

When an angle between the fence components 7 requires to be adjusted, as the tooth groove 5 at the bottom of the insertion plate 4 fits into the shallow tooth groove 11 on the upper part of the locking piece 17, as shown in FIG. 2, during pressing the unlocking button 2 downwards, the tooth groove 5 slowly enters the shallow tooth groove 11. During entering, the tooth groove 5 not only drives the shallow tooth groove 11 to rotate by a certain angle, but also exerts a vertical force that drives the shallow tooth groove 11 and the locking piece 17 to move downwards together. At this point, the reset spring 10 arranged on the outer side of the locking piece 17 and positioned between the upper corner joint 1 and the lower corner joint 8, is compressed and gains tension. During the downward movement of the locking piece 17, the deep tooth groove 12 disengages from the locking teeth 19, transitioning from an engaged state to a disengaged state. As the locking piece 17 moves downwards, the outer tooth ring 13 on the locking piece 17 disengages from the inner tooth ring 9 on the lower corner joint 8, causing the locking piece 17 to lose its restraint on the upper corner joint 1 and the lower corner joint 8. At this point, the fence components 7 can be adjusted.

Teeth outside the locking teeth 19 are not inserted into grooves at the edge of the deep tooth groove 12, but rather the teeth of the locking teeth 19 and teeth of the deep tooth groove 12 abut against each other. Similarly, the inner tooth ring 9 and the outer tooth ring 13 below do the same. The fence component 7 will not be locked even if the external force is removed at this time. When the unlocking button 2 is pressed again, the tooth groove 5 drives the shallow tooth groove 11 to rotate a certain distance. At this point, the teeth outside the locking teeth 19 align with the grooves at the edge of the deep tooth groove 12, and the inner tooth ring 9 and the outer tooth ring 13 below do the same. At this point, after removing the external force from the unlocking button 2, the deep tooth groove 12 can be effectively pushed into the locking teeth 19 under the tension of the reset spring 10, and the inner tooth ring 9 and the outer tooth ring 13 can engage with each other.

After the unlocking button 2 is mounted inside the insertion slot 6, to prevent the negative pressure generated inside the structure, the base 14 is designed as a hollow structure with a convex middle part. Additionally, the interior of the locking piece 17 is hollow, with an open lower end. The first communicating hole 20 and the second communicating hole 21 are dispersed on the locking piece 17 and the base 14, respectively, to facilitate air convection, preventing the unlocking button 2, when requires to be pulled out, from becoming stuck due to negative pressure.

The above mentioned are only the better embodiments of the present disclosure, rather than the limitation to the present disclosure. Within the technical scope disclosed by the present disclosure, any modifications or replacements made by any skilled familiar with the technical field of the present disclosure shall be covered by the scope of protection of the present disclosure.

1. A playpen connecting piece, comprising an upper corner joint (1) and a lower corner joint (8), with the upper corner joint (1) and the lower corner joint (8) rotatably connected to adjacent playpen components (7) respectively, wherein
an insertion slot (6) is disposed at an upper part of the upper corner joint (1), and an unlocking button (2) is inserted into the insertion slot (6); a locking piece (17) is sleeved between inner sides of the upper corner joint (1) and the lower corner joint (8); a reset spring (10) is sleeved on a lower end of an outer side of the locking piece (17); an angle adjustment structure is arranged between a top of the locking piece (17) and the unlocking button (2); and the angle adjustment structure serves for adjusting an angle between the upper corner joint (1) and the lower corner joint (8); and
a first locking structure is arranged between an upper part of the locking piece (17) and the upper corner joint (1), and a second locking structure is arranged between a lower part of the locking piece (17) and the lower corner joint (8).

2. The playpen connecting piece according to claim 1, wherein the angle adjustment structure comprises a partition plate (18), an insertion plate (4), a through hole (16), a tooth groove (5), and a shallow tooth groove (11); the partition plate (18) is mounted on an inner side of the insertion slot (6); the through hole (16) is disposed on the partition plate (18); the tooth groove (5) is disposed at a bottom of the insertion plate (4); the insertion plate (4) passes through the through hole (16) and extends below the partition plate (18); and the tooth groove (5) and the shallow tooth groove (11) cooperate with each other.

3. The playpen connecting piece according to claim 2, wherein the first locking structure comprises a deep tooth groove (12) and locking teeth (19); the locking teeth (19) are arranged in a circular array on the inner side of the upper corner joint (1); the deep tooth groove (12) is mounted at an upper end of an outer side of the locking piece (17); and the deep tooth groove (12) and the locking teeth (19) cooperate with each other.

4. The playpen connecting piece according to claim 3, wherein when the locking piece (17) descends, the deep tooth groove (12) disengages from the locking teeth (19).

5. The playpen connecting piece according to claim 4, wherein the second locking structure comprises an outer tooth ring (13) and an inner tooth ring (9); the inner tooth ring (9) is arranged inside the lower corner joint (8), and the outer tooth ring (13) is mounted at a lower part of the outer side of the locking piece (17); and when the upper corner joint (1) and the lower corner joint (8) are locked, the outer tooth ring (13) is clamped on an inner side of the inner tooth ring (9), and the inner tooth ring (9) cooperates with the outer tooth ring (13).

6. The playpen connecting piece according to claim 5, wherein when the upper corner joint (1) and the lower corner joint (8) are in an unlocked state, the outer tooth ring (13) descends until the outer tooth ring (13) disengages from the inner tooth ring (9).

7. The playpen connecting piece according to claim 6, wherein through-type positioning holes (15) are uniformly disposed on the partition plate (18), positioning blocks (3) are mounted at a lower end of the unlocking button (2), and the positioning blocks (3) are inserted into the positioning holes (15) at different positions.

8. The playpen connecting piece according to claim 7, wherein the unlocking button (2) is circular and a size thereof matches that of the insertion slot (6).

9. The playpen connecting piece according to claim 8, wherein a base (14) is clamped at a bottom of the lower corner joint (8).

10. The playpen connecting piece according to claim 9, wherein a through-type first communicating hole (20) is disposed at the top of the locking piece (17), a through-type second communicating hole (21) is disposed in a middle portion of the base (14), and the first communicating hole (20) passes through the locking piece (17) to be intercommunicated with the second communicating hole (21).
